(19) United States
(12) Patent Application Publication
(10) Pub. No.: US 2016/0080405 A1
(43) Pub. Date: Mar. 17, 2016

(54) Detecting Anomalous Interaction With Online Content

(71) Applicant: Sizmek, Inc., Atlanta, GA (US)

(72) Inventors: Jonathan Schler, Petach Tikwa (IL); David Woods, Marietta, GA (US); Justin Haygood, Marietta, GA (US); Brian Bober, Smyrna, GA (US)

(21) Appl. No.: 14/486,596

(22) Filed: Sep. 15, 2014

(51) Int. Cl. H04L 29/06

(52) U.S. Cl. CPC H04L 63/1425

(57) ABSTRACT

Certain embodiments relate to identifying potentially fraudulent interactions with online content. An analytical application executed on a server or other computing device can identify first and second actives areas of an electronic content item that are distinguishable from one another based on a sensory indicator presented with the electronic content item. One or more actions may be performed in response to receiving inputs to the first active area or the second active area. The analytical application can receive inputs to the electronic content item from an entity. At least a subset of the inputs can include interactions that are received within the second active area rather than the first active area. The analytical application can determine that activity by the entity is anomalous based on the subset of the interactions being within the second active area rather than the first active area.

### TECHNICAL FIELD

This disclosure relates generally to computer-implemented methods and systems and more particularly relates to detecting anomalous interactions with online content.

### BACKGROUND

Online content providers can use web analytics tools and techniques that collect and analyze web data to improve the quality and effectiveness of online content. These web analytics tools and techniques can collect information about interactions with online content by website visitors, thereby allowing the online content providers to better understand and serve those visitors. For example, analytics for online advertising content can be used to track the effectiveness of a given advertising campaign, such as the number of clicks on a given advertisement and the percentage of those clicks that resulted in the sale of an advertised product or service. Analytics tools can also allow content providers to accurately value pay-per-click services, in which advertisers are permitted to present advertisements on a website and are charged fees based on how frequently users click or otherwise interact with the presented advertisements.

The effectiveness of analytics tools can be undermined by fraudulent interactions with online content. For example, fraudulent clicking can involve an entity repeatedly clicking on a competitor's advertisement after the advertisement is presented. Some fraudulent interactions are performed automatically by programs such as bots (also known as “clickbots,” “hitbots,” etc.). A “bot” can be an application or other software that automates one or more tasks for accessing web content. Fraudulently clicking on an advertisement can make the advertisement appear less effective. For example, fraudulent clicking can cause the number of clicks on an advertisement to greatly exceed the number of sales associated with the advertisement, thereby undermining attempts to assess the accuracy of the advertisement. Furthermore, fraudulently clicking on a competitor's advertisement in a pay-per-click service can cause the competitor to incur additional advertising fees without providing any sales benefit.

Systems and methods are desirable for identifying potentially fraudulent interactions with advertisements and other online content.

### SUMMARY

According to certain embodiments, an analytical application executed on a server or other computing device can identify potentially fraudulent interactions with online content. The analytical application can identify a first active area of an electronic content item (e.g., an advertisement) and a second active area of the electronic content item. The first active area is distinguishable from the second active area by at least one visible boundary or other sensory indicator presented with the electronic content item. One or more actions may be performed in response to receiving input to the first active area or the second active area (e.g., accessing a web page in response to clicking a hyperlinked portion of an advertisement). The analytical application can also receive inputs to the electronic content item from an entity via a data network, a communication bus, or other electronic communication channel. At least a subset of the inputs can include interactions that are within the second active area rather than the first active area. The analytical application can determine that activity by the entity is anomalous based at least partially on the subset of the interactions being within the second active area rather than the first active area.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings, where:

FIG. 1 is a block diagram depicting a server system for identifying potentially fraudulent interactions with online content according to certain exemplary embodiments;

FIG. 2 is a modeling diagram depicting an example of an electronic content item that can include visually distinguishable active areas used for identifying anomalous interactions with the content item according to certain exemplary embodiments;

FIG. 3 is a flow chart illustrating an example of a method for identifying potentially fraudulent interactions with online content according to certain exemplary embodiments;

FIG. 4 is a modeling diagram depicting an alternative example of online content that can include multiple visually distinguishable active areas used for identifying anomalous interactions with the content according to certain exemplary embodiments;

FIG. 5 is a modeling diagram depicting an example of a click density map that can be used to identify distinguishable active areas used for identifying anomalous interactions according to certain exemplary embodiments; and

FIG. 6 is a block diagram depicting an example of a server system for implementing certain embodiments.

### DETAILED DESCRIPTION

Computer-implemented systems and methods are disclosed for identifying potentially fraudulent interactions with online content. An analytical application executed by a server or other suitable computing device can use visually distinguishable portions of an advertisement or other online content to identify potentially fraudulent or otherwise anomalous interactions with the advertisement or other online content. For example, the analytical application can determine a distribution of clicks or other interactions between a first active portion of an advertisement, which is presented with visual characteristics or other sensory indicators intended to draw a user's attention (e.g., a “Click Here” label, a braille texture, etc.), and a second active portion of the advertisement, which may lack these visual characteristics or other sensory indicators (e.g., clickable white space). If an entity frequently clicks active portions of the advertisement that lack any visual characteristics intended to draw a user's attention, the entity is more likely to be a bot or other software that is automatically clicking at random positions on the advertisement. If the entity's activity is determined to be fraudulent, subsequent activity by the entity can be ignored when performing analytics on the online content.

In accordance with some embodiments, an analytical application can identify a first active area of a web page or other electronic content item and a second active area of the web page. An active area can be a portion of a web page or other content item that can receive inputs that cause one or more actions to be performed in response to the input. For example, an active area may be a hyperlinked area that causes a web browser to navigate to a given website in response to being clicked. The first active area is distinguishable from the second active area based on a sensory indicator presented with the electronic content item, such as (but not limited to) at least one visible boundary or other visual characteristic. For example, a developer of an advertisement may include certain visual characteristics (e.g., a drawing of a button, a “Click Here” message, etc.) that can influence a user to click that area of the advertisement. The developer may leave other clickable areas of the advertisement as blank space. The analytical application can determine that inputs to the web page received from a given entity include at least some interactions that are within the second active area rather than the first active area. For example, a greater percentage of clicks may be received in a clickable area that includes blank space than a clickable area that has the appearance of a button or includes a “click here” label. The analytical application can determine that activity by the entity is anomalous based at least partially on the subset of the interactions being within the second active area. For example, if a given entity consistently clicks on nondescript active areas of different advertisements rather than visually distinctive areas of the advertisements, the interactions with the nondescript areas may indicate that the entity is actually a bot or other automated software.

As used herein, the term “electronic content item” is used to refer to any content that can be presented via a web site or other provider of online content. Non-limiting examples of electronic content items include pop-up advertisements, advertisements embedded in other web pages, notifications presented to a user via a web page, etc.

As used herein, the term “active area” is used to refer to a portion of an electronic content item that can cause one or more actions to be performed in response to an interaction with the portion of the electronic content item. One non-limiting example of an active area is a portion of an electronic content item that is linked to a web page or other electronic content item. Another non-limiting example of an active area is a portion of an electronic content item that causes an e-mail application to generate a draft message addressed to a recipient specified by metadata in the active portion.

As used herein, the term “sensory indicator” is used to refer to any visual characteristic, audible characteristic, tactile characteristic, or other attribute of electronic content that may be detectable by human senses. In one non-limiting example, a sensory indicator may include a visible border or other visual characteristic that is displayed with electronic content. In another non-limiting example, a sensory indicator may include an audio signal that is played during at least some of a time period in which an electronic content item is displayed, such as a message or noise that is played when a cursor hovers over an active area or that instructs a user to click a certain portion of the content item. In another non-limiting example, a sensory indicator may include a tactile characteristic of a display device that is modified in a region at which the electronic content item is displayed (e.g., a braille section providing a “Click Here” message).

As used herein, the term “entity” is used to refer to a user or other logical entity that can be uniquely identified by an analytical application. Non-limiting examples of entities include individuals, organizations, automated software agents and other applications, etc. A given entity can be identified by reference to one or more client accounts, by reference to a software identifier and/or hardware identifier associated with an application and/or device used to access the server system (e.g., a network address), etc.

Referring now to the drawings, FIG. 1 is a block diagram depicting a server system 102 that can identify potentially fraudulent interactions with online content.

The server system 102 can execute a content application 104 for providing access to content items 106a, 106b. For example, the content application 104 may be an application used for hosting a web site. The content item 106a may be a web page for the web site. The content item 106b may be an advertisement presented within or along with the content item 106a.

The server system 102 can also execute an analytical application 107. The analytical application 107 can monitor or otherwise communicate with the content application 104 to obtain data regarding interactions with the content items 106a, 106b. For example, the analytical application 107 can receive a log or other data file that describes each interaction with a content item, a position of the interaction with respect to the content item, a network address or other identifier associated with an entity performing the interaction, etc. As described in detail below, the analytical application 107 can analyze the data obtained from the content application 104 to identify potentially fraudulent interactions with one or more of the electronic content items 106a, 106b.

In some embodiments, the same server system 102 can execute both the content application 104 and the analytical application 107, as depicted in FIG. 1. In other embodiments, different server system can execute the content application 104 and the analytical application 107.

The server system 102 can communicate via a data network 108 with computing devices 110a, 110b. The computing devices 110a, 110b can be any suitable devices configured for executing client applications 112a, 112b. Non-limiting examples of a computing device include a desktop computer, a tablet computer, a laptop computer, or any other computing device. Non-limiting examples of the client applications 112a, 112b include web browser applications, dedicated applications for accessing one or more of the content items 106a, 106b, etc. Data describing interactions with the content items 106a, 106b can be associated with entities that use the computing devices 110a, 110b (e.g., user names), with the computing devices 110a, 110b themselves (e.g., network addresses of the computing devices 110a, 110b), or some combination thereof.

Although FIG. 1 depicts various functional blocks at different positions for illustrative purposes, other implementations are possible. For example, although FIG. 1 depicts a single server system 102 that hosts two electronic content items 106a, 106b and that communicates with two computing devices 110a, 110b, any number of server systems in communication with any number of other computing devices can provide access to any number of content items. For example, the server system 102 can include multiple processing devices in multiple computing systems that are configured for providing access to virtualized computing resources using cloud-based computing, grid-based computing, cluster-based computing, and/or some other suitable distributed computing topology. FIG. 1 also depicts the content application 104 and the analytical application 107 as separate functional blocks for illustrative purposes. However, in some embodiments, one or more functions of the content application 104 and the analytical application 107 can be performed by a common application. In other embodiments, additional software modules or other application can perform one or more functions of the content application 104 and/or the analytical application 107.

As depicted in FIG. 1, the computing device 110b can also execute a bot 114. The bot 114 can be an application or other software that automates one or more tasks for accessing one or more of the content items 106a, 106b. For example, the content item 106b may be an advertisement that is presented with a content item 106a, such as a web page. The user of a bot 114 may be a competitor of the provider of the advertisement in the content item 106b. The bot 114 may automatically access the content items 106a, 106b. The bot 114 may repeatedly click on the advertisement in the content item 106b.

The analytical application 107 can be used to detect interaction with the content items 106a, 106b by the computing device 110b that is indicative of fraudulent or otherwise anomalous activity performed by a bot 114. The analytical application 107 can use one or more visually distinguishable active areas of an electronic content item to determine which interactions with the content item are more likely to have been performed by a bot 114 or other entity involved in fraudulent interactions with one or more of the content items 106a, 106b.

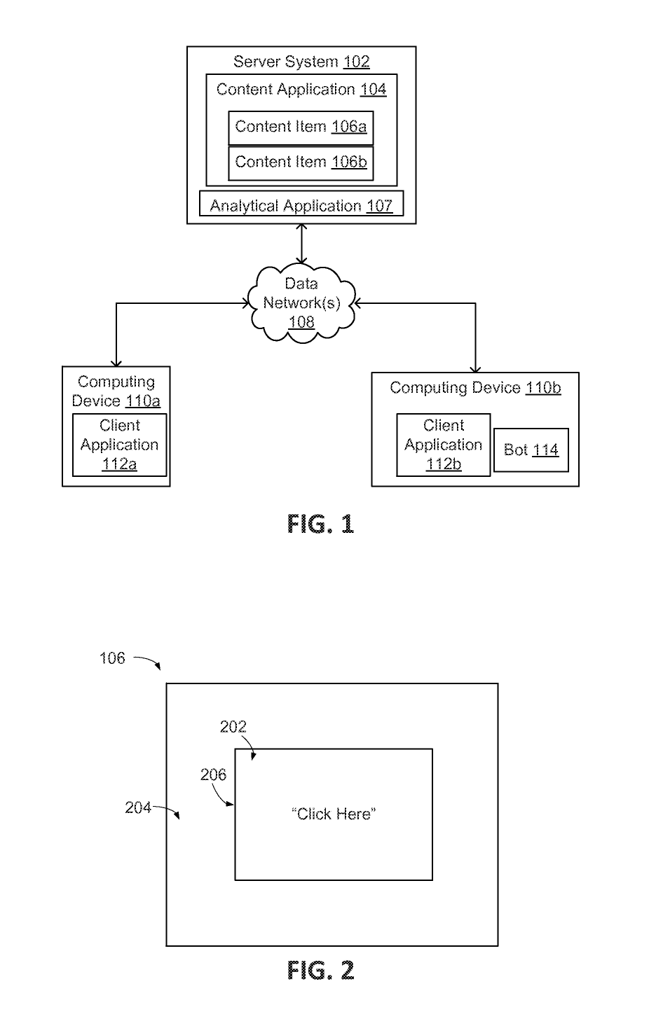

For example, FIG. 2 is a modeling diagram depicting an example of an electronic content item 106 that can include visually distinguishable active areas used for identifying anomalous interactions. The description with respect to the electronic content item 106 can apply to one or both of the content items 106a, 106b.

The electronic content item 106 can include an active area 202 that has the appearance of a button with a label “Click Here.” The active area 202 can be delineated or otherwise indicated by a visible boundary 206 or other visual characteristics. The boundary 206 or other visual characteristic is visible when the content item 106 is displayed in a graphical interface of one or more of the client applications 112a, 112b. Using the boundary 206 or another visual characteristic to delineate the active area 202 can influence a user to click on the active area 202.

The electronic content item 106 can also include an active area 204 that is visually distinguishable from the active area 202. The boundary 206 or another suitable visual characteristic can visually distinguish the active areas 202, 204. For example, the active area 204 can include white space or some other visual characteristic that is less distinctive than the visual characteristics of the active area 202. The visual distinctions between the active areas 202, 204 can influence a user to click on the active area 202.

The developer may not need to specify any difference in behavior between interactions with the active area 202 and interactions with the active area 204. For example, clicking on the “Click Here” portion in the active area 202 may cause the same result as clicking on the blank portion in the active area 204. Having multiple active areas 202, 204 that are distinguishable by a boundary 206 or other suitable visual characteristic may obviate the need to include multiple interface objects providing different functionality within the electronic content item 106. For example, a developer of an electronic content item 106 such as an advertisement can designate any visible portion of the electronic content item 106 as a clickable area rather than including a clickable button or other interface object in the electronic content item 106.

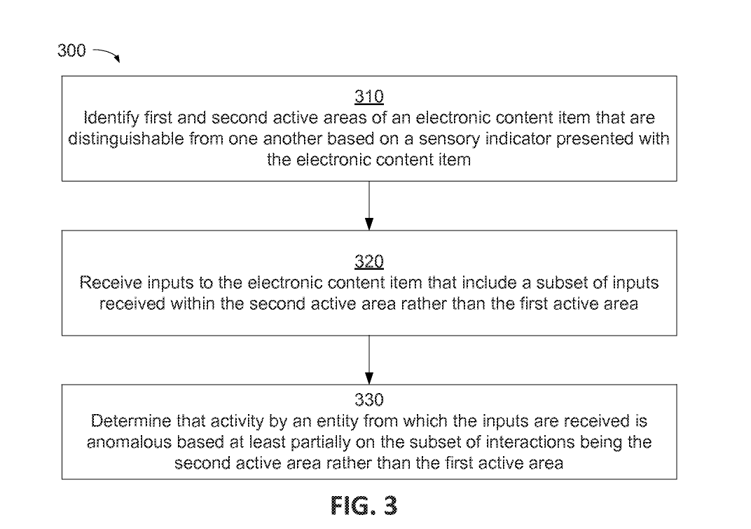

The active areas 202, 204 can be used to distinguish interactions with the electronic content item 106 that are more likely to have been performed by a human user from interactions with the electronic content item 106 that are more likely to have been performed by the bot 114. For example, FIG. 3 is a flow chart illustrating an example of a method 300 for identifying potentially fraudulent interactions with online content. For illustrative purposes, the method 300 depicted in FIG. 3 is described in reference to the implementation depicted in FIGS. 1 and 2. Other implementations, however, are possible

The method 300 involves identifying a first active area 202 of an electronic content item 106 and a second active area 204 of the electronic content item 106 that is visually distinguishable from the first active area 202, as depicted in block 310. For example, a suitable processing device of the server system 102 can execute one or both of the content application 104 and the analytical application 107 to identify the active areas 202, 204.

The locations of the active areas 202, 204 within an electronic content item 106 can be identified and stored in any suitable manner. In a non-limiting example, specific pixel locations, regions defined by HTML tags that correspond to the active areas 202, 204, or other suitable identifiers can be used to identify the active areas 202, 204. The identifiers for the active areas 202, 204 can be stored in a database or other suitable data structure in a non-transitory computer-readable medium that is included in or accessible to the server system 102.

The first and second active areas 202, 204 can be identified via any suitable process. In some embodiments, a developer of a content item 106 can include data in the content item 106 or can otherwise associate data with the content item 106 that identifies the first active area 202 and the second active area 204. For example, a developer or other entity can use drawing inputs or other suitable inputs in a graphical interface of a development application (e.g., an HTML editor) to specify the active areas 202, 204. The active areas 202, 204 can be specified using one or more sensory indicators that may be presented to a user when the electronic content item 106 is displayed.

In some embodiments, a development application can be used to designate one or more of the active areas 202, 204 using at least one visible characteristic to delineate or otherwise specify the active area. Such a visible characteristic may be visible when the electronic content item 106 is displayed in a graphical interface. For example, a developer can draw or otherwise generate one or more visible boundaries that delineate the active areas 202, 204. In additional or alternative embodiments, the inputs to the development application can designate one or more of the active areas 202, 204 using at least one audible characteristic that can be used to distinguish the active areas 202, 204 when the electronic content item 106 is displayed in a graphical interface. In one non-limiting example, the development application can be used to specify that if a cursor hovers over an active area 202, an audio file (e.g. “Click me!”) is played. In another non-limiting example, the development application can be used to specify that when the electronic content item 106 is displayed, an audio file is played that includes instructions or suggestions to click the active area 202 (e.g., “Click the icon shaped like a triangle to win $1000”). In additional or alternative embodiments, the inputs to the development application can designate one or more of the active areas 202, 204 using at least one tactile characteristic that distinguishes the active areas 202, 204 from one another when the electronic content item 106 is displayed in a graphical interface. For example, the development application can be used to specify that electroactive polymers, mechanical pins, or other suitable structures of a display device are to be configured to provide a specific texture or other tactile characteristic (e.g., braille dots) in the active area 202 when the electronic content item 106 is displayed in a graphical interface.

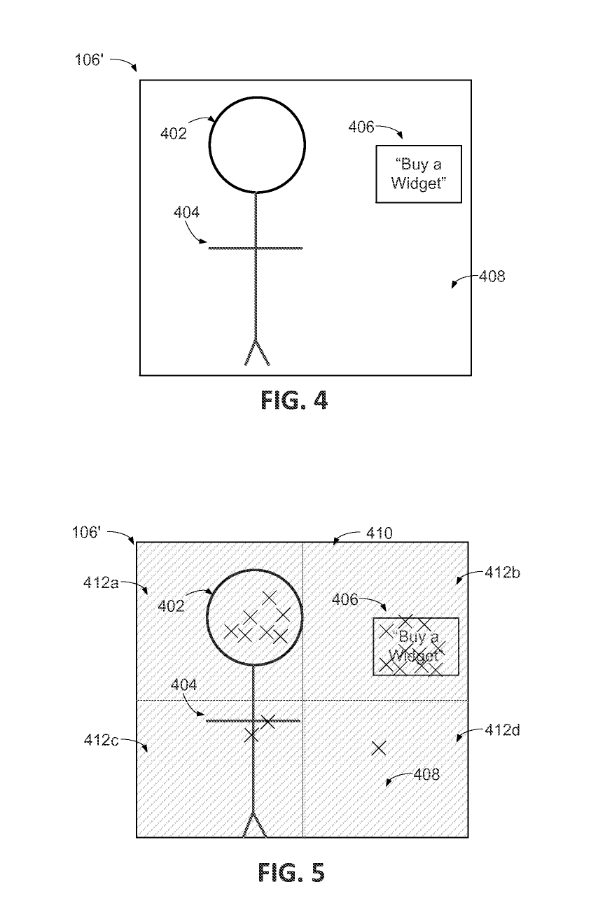

In additional or alternative embodiments, the first and second active areas 202, 204 can be identified at least partially based on click densities within the electronic content item 106. For example, multiple portions of a content item 106 may include visually appealing characteristics. Historical click densities on the various portions of the electronic content items 106 can be used to designate one or more active areas that are used to identify anomalous clicks. Additional details regarding the use of click densities to identify active areas 202, 204 are provided herein with respect to FIGS. 4 and 5.

In some embodiments, the active areas 202, 204 can include any portion of a content item 106 that is presented in a graphical interface. For example, any graphical content of the content item 106 that is presented in an interface of a client application may be clickable, such that clicking on any portion of the content item 106 can cause a web page to be retrieved or another action to be performed. In other embodiments, the content item 106 can include active areas 202, 204 as well as one or more inactive portions that are presented in a graphical interface of a client application. No action may be performed in response to clicking on or otherwise interacting with the inactive areas.

The method 300 also involves receiving electronic data indicative of inputs to the electronic content item 106 from an entity, where at least a subset of the inputs include interactions that are within the second active area 204 rather than the first active area 202, as depicted in block 320. In some embodiments, the electronic data indicative of inputs to the electronic content item 106 can be received by a server system 102 via a data network 108. For example, the analytical application 107, which can be executed by a suitable processing device, can receive data describing inputs or other interactions with the content item 106 by one or more entities. The analytical application 107 can receive the data via a data network 108 from one or more of the client applications 112a, 112b or from other applications executed at the computing devices 110a, 110b that monitor interaction with electronic content presented via the client applications 112a, 112b. The data describing the inputs or other interactions with the content item 106 can indicate a respective position on the electronic content item 106 at which each input or other interaction occurred. The analytical application 107 can determine which of the inputs or other interactions occurred within the active area 204 used to identify anomalous activity. For example, clicks that occurred at positions outside the boundary 206 can be included in a subset of inputs or other interactions that occurred within the second active area 204.

The data describing the inputs or other interactions with the electronic content items can be generated by any suitable input events generated at the computing devices 110a, 110b. Suitable input events can include data generated in response to a user of the computing device interacting with one or more input devices such as a mouse, a touch screen, a keyboard, a microphone, etc. In some embodiments, the input events can identify a location at which an interaction with a content item 106 occurred. For example, an input event can identify a pixel coordinate, a display coordinate, an HTML region, or other data corresponding to a region of a display screen at which a content item 106 is presented. The input event can also include data identifying an entity that performed the input event (e.g., a user name or other identifier of an entity that has logged into a computing device at which a content item 106 is presented, a user name or other identifier of an entity that has logged into a website in which the content item 106 is presented, a hardware identifier of the computing device that generated the input event, etc.). In additional or alternative embodiments, the input events can identify a time of an interaction with an input device. For example, an electronic content item 106 may present one or more prompts for a user to speak a command or other message. The command or other message spoken by the user can be detected by an input device such as a microphone. The detection of the command or other message can generate an input event that includes a time-stamp of the detection (e.g., a time of day, a duration between when the prompt was presented and when the user's voice was detected, etc.).

The method 300 also involves determining that activity by the entity is anomalous based at least partially on the subset of the interactions being within the second active area 204 rather than the first active area 202, as depicted in block 330. For example, the analytical application 107 can be executed by a suitable processing device to determine that the amount of interaction with the second active area 204 is statistically significant or otherwise exceeds some threshold. The analytical application 107 can identify the entity as a source of potentially fraudulent or otherwise anomalous activity (e.g., a potential bot 114) based on the subset of the interactions being within the second active area 204 rather than the first active area 202.

In some embodiments, the analytical application 107 can use a threshold amount of interaction with the second active area 204 to identify an entity as a source of potentially fraudulent or otherwise anomalous activity. The analytical application 107 can be executed by a processor to perform one or more operations for determining that the subset of the inputs includes an amount of interaction within the second active area 204 that is greater than the threshold amount of interaction. For example, the analytical application 107 can access data stored in a non-transitory computer-readable medium that identifies the threshold amount of interaction. The threshold amount of interaction can be specified, determined, or otherwise identified and stored in in the non-transitory computer-readable medium in any suitable manner. The analytical application 107 can perform an operation for comparing the threshold amount of interaction (e.g., a threshold number of click events or other input events) with the subset of the inputs (e.g., a number of input events generated by the entity and provided to the analytical application). If the subset of the inputs exceeds the threshold amount of interaction, the analytical application 107 can output a command, a notification, or other electronic data that identifies the entity as a source of potentially fraudulent or otherwise anomalous activity.

In some embodiments, the analytical application 107 can identify the threshold amount of interaction with the second active area 204 based on historical amounts of interaction with the active areas 202, 204. For instance, the analytical application 107 can determine that a given percentage of users click the active area 202 rather than the active area 204 when interacting with the electronic content item 106. The analytical application 107 can determine the threshold amount of interaction based on the percentage of users that click the active area 202. In additional or alternative embodiments, the threshold amount of interaction with the second active area 204 can be specified by a developer of the electronic content item 106, a provider of the electronic content item 106, an operator of the server system 102, or some other entity responsible for configuring the analytical application 107 to identify potentially fraudulent activity. For example, a user of the analytical application 107 can specify a threshold amount of interaction with the active area 202 that is indicative of potentially fraudulent or otherwise anomalous activity.

In additional or alternative embodiments, the analytical application 107 can identify an entity as a source of potentially fraudulent or otherwise anomalous activity by using a threshold amount of time between the presentation of a sensory indicator and the interaction with the electronic content item 106. The analytical application 107 can be executed by a processor to perform one or more operations for determining that each of the subset of the inputs occurred sooner than or later than a threshold duration between the presentation of a sensory indicator and the interaction with the electronic content item 106. A non-limiting example of a threshold duration is an average or median duration. The analytical application 107 can access data stored in a non-transitory computer-readable medium that identifies the threshold duration. The threshold duration can be specified, determined, or otherwise identified and stored in in the non-transitory computer-readable medium in any suitable manner. The analytical application 107 can perform an operation for comparing the threshold duration with the durations between the presentation of a sensory indicator and times at which the subset of the inputs occurred. If the subset of the inputs occurred at times sooner than or later than the threshold duration, the analytical application 107 can output a command, a notification, or other electronic data that identifies the entity as a source of potentially fraudulent or otherwise anomalous activity.

In additional or alternative embodiments, the analytical application 107 can identify an entity as a source of potentially fraudulent or otherwise anomalous activity by analyzing the entity's interaction with multiple electronic content items 106. For example, the content application 104 can present multiple electronic content items 106 to users of the computing devices 110a, 110b. Each of the electronic content items 106 can include at least one respective active area 202 (e.g., a “click here” label or other visually distinctive portion) that is visually distinguishable from at least one respective active area 204 (e.g., a blank space or other visually nondescript portion). Inputs can be received from the entity for each of the electronic content items 106. For each of the electronic content items 106, the analytical application 107 can determine that the inputs from the entity include a respective amount of interaction with the active area 204 rather than the active area 202. The analytical application 107 can determine that the entity is a source of potentially fraudulent or otherwise anomalous activity based on the entity repeatedly interacting with active areas 204 of multiple electronic content items 106 in a manner that is associated with automated software rather than human interaction.

In some embodiments, the analytical application 107 can report the anomalous activity to another entity. For example, the analytical application 107 may be executed on a third party server system 102 that is distinct from a server system used to perform analytics for content presented by the content application 104. The analytical application 107 can transmit a notification to the separate analytics server system that anomalous interactions have been received from the potentially fraudulent entity. The separate analytics server system can perform one or more corrective actions in response to receiving the notification (e.g., disregarding subsequent clicks received from the identified entity).

In other embodiments, the analytical application 107 can perform one or more corrective actions based on determining that the entity is a source of potentially fraudulent or otherwise anomalous activity. For example, the analytical application 107 may receive additional inputs associated with the entity subsequent to determining that historical activity by the entity is anomalous. The analytical application 107 can exclude the subsequently received inputs from an analytical process based on determining that the activity by the entity is anomalous.

Although the method 300 is described above as being executed by an analytical application 107 executed at a server system 102 that is remote from the computing devices 110a, 110b, other implementations are possible. For example, in some embodiments, one or more software modules of an analytical application 107 can be executed at one or more of the computing device 110a, 110b. The one or more software modules can perform one or more of the operations described above with respect to blocks 310-330 of method 300. In some embodiments, one or more processing devices of the server system 110 can perform the operations described above with respect to blocks 310-330. In additional or alternative embodiments, one or more processing devices of the computing devices 110a, 110b can execute one or more suitable software modules to perform some or all of the operations described above with respect to blocks 310-330. For example, a processing device executing the one or more suitable software modules can receive data indicative of inputs to the electronic content item 106 via a communication bus that communicatively couples the processing device to an input device (e.g., a mouse, a touchscreen, a keyboard, etc.) of the computing device.

In some embodiments, click density can be used to suggest or otherwise identify active area 202. For example, FIG. 4 is a modeling diagram depicting an electronic content item 106′ that can include multiple visually distinguishable active areas, which may be used for identifying anomalous interactions with the content. The content item 106′ depicted in FIG. 4 includes a picture of a person having a head 402 and a body 404. The content item 106′ also includes a graphic 406 with the text “Buy a Widget.” The content item 106′ also includes blank space 408. The same action can be triggered in response to clicking any of the head 402, the body 404, the graphic 406, and the blank space 408. The analytical application 107 can receive data that describes inputs received by the content item 106′. The inputs can be received via clicks or other interactions with different portions of the content item 106′.

The analytical application 107 can determine a distribution of interactions among different portions of the content item 106′. For example, the analytical application 107 may generate a click density map for the content item 106′, such as the click density map 410 having regions 412a-d depicted in FIG. 5. (Although FIG. 5 depicts a simplified example of a click density map 410 having four regions 412a-d for illustrative purposes, any number of regions can be included in a click density map.) The click density map can indicate the relative frequency at which users click on different portions of the content item 106′. For example, 50% of clicks (each of which is depicted as an “X” in FIG. 5) may occur on the graphic 406 (i.e., region 412b), 35% of clicks may occur on the head 402 (i.e., region 412a), 10% of the clicks may occur on the body 404 (i.e., region 412c), and 5% of clicks may occur on the blank space 408 (i.e., region 412d).

The analytical application 107 can designate one or more portions of the electronic content item 106′ as call-to-action areas and one or more other portions of the electronic content item 106′ as potentially anomalous interaction areas based on the historical distribution of interactions among different portions of the content item 106′. A call-to-action area can include an active area of the electronic content item 106′ with which a human user (as opposed to an automated bot) is more likely to interact. A potentially anomalous interaction area can include an active area of the electronic content item 106′ with which a human user (as opposed to an automated bot) is less likely to interact. By contrast, if an automated bot 114 randomly interacts with different portions of the electronic content item 106′, the automated bot 114 may be equally likely to interact with both call-to-action areas and potentially anomalous interaction areas. For example, if a higher percentage of historical interactions have occurred with respect to the graphic 406 and the head 402 as compared to the body 404 or the blank space 408, then subsequent interactions with the graphic 406 and the head 402 are more likely to result from a human user interacting with those areas. If an entity interacts with the graphic 406 and the blank space 408 at comparable frequencies, then the entity is more likely to be a bot 114.

In additional or alternative embodiments, a developer of an electronic content item 106 can modify suggested designations for call-to-action areas and potentially anomalous areas that have been automatically determined by the analytical application 107 (e.g., based on historical click densities or other analyses of historical interactions with the electronic content item 106). For example, the analytical application 107 can generate a click density map indicating that 50% of clicks occur on the graphic 406, 35% of clicks occur on the head 402, and 15% of the clicks occur on the body 404 or on the blank space 408. The analytical application 107 can generate suggested designations of the graphic 406 and the head 402 as call-to-action areas and suggested designations of the body 404 and the blank space 408 as potentially anomalous interaction areas. A developer of the electronic content item 106′ may modify the suggested designations such that the body 404 is also identified as a call-to-action area, even if the historical click density for the body 404 is significantly lower than the click densities for the head 402 or the graphic 406. The designated call-to-action areas and potentially anomalous interaction areas as generated by the analytical application 107 and modified by the developer can be used in the method 300.

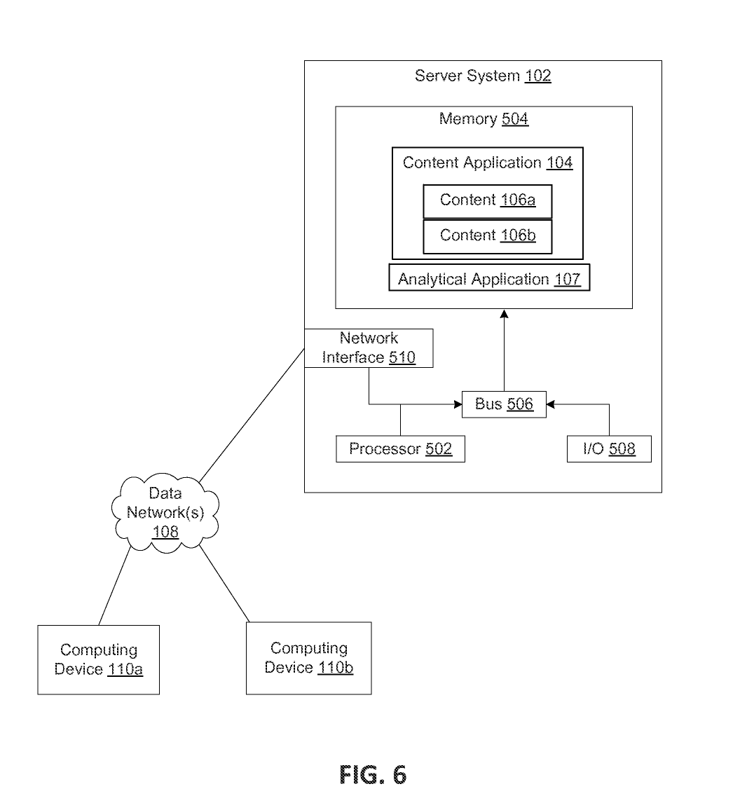

Any suitable server or other computing system can be used to execute the analytical application 107. For example, FIG. 6 is a block diagram depicting an example of a server system 102 for implementing certain embodiments.

The server system 102 can include a processor 502 that is communicatively coupled to a memory 504 and that executes computer-executable program instructions and/or accesses information stored in the memory 504. The processor 502 may comprise a microprocessor, an application-specific integrated circuit (“ASIC”), a state machine, or other processing device. The processor 502 can include any of a number of processing devices, including one. Such a processor can include or may be in communication with a computer-readable medium storing instructions that, when executed by the processor 502, cause the processor to perform the operations described herein.

The memory 504 can include any suitable computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The server system 102 may also include a number of external or internal devices such as input or output devices. For example, the server system 102 is shown with an input/output (“I/O”) interface 508 that can receive input from input devices or provide output to output devices. A bus 506 can also be included in the server system 102. The bus 506 can communicatively couple one or more components of the server system 102.

The server system 102 can execute program code for the analytical application 107. The program code for the analytical application 107 may be resident in any suitable computer-readable medium and may be executed on any suitable processing device. The program code for the analytical application 107 can reside in the memory 504 at the server system 102. The analytical application 107 stored in the memory 504 can configure the processor 502 to perform the operations described herein.

The server system 102 can also include at least one network interface 510. The network interface 510 can include any device or group of devices suitable for establishing a wired or wireless data connection to one or more data networks 108. Non-limiting examples of the network interface 510 include an Ethernet network adapter, a modem, and/or the like.

Although FIG. 6 depicts a single functional block for the server system 102 for illustrative purposes, any number of computing systems can be used to implement the server system 102. For example, the server system 102 can include multiple processing devices in multiple computing systems that are configured for cloud-based computing, grid-based computing, cluster-based computing, and/or some other suitable distributed computing topology.

In some embodiments, detecting anomalous interactions with online content as described herein can improve one or more functions performed by a system that includes multiple mobile devices or other computing devices in communication with servers that transmit and receive electronic communications via a data network. In a non-limiting example, an analytical application 107 can exclude the subsequently received inputs from an analytical process based on determining that the activity by the entity is anomalous or otherwise facilitate one or more other applications in discouraging activity by a fraudulent or otherwise anomalous account (e.g., by disabling the account). Excluding subsequently received inputs from an analytical process based on determining that activity by an entity is anomalous can decrease the amount of processing resources (e.g., memory, processing cycles, etc.) used by a computing device that executes the analytical application 107. Decreasing the amount of processing resources used by the computing device for processing fraudulent or otherwise anomalous clicks can increase the efficiency of the computing device in performing other tasks. Discouraging activity by a fraudulent or otherwise anomalous account (e.g., by disabling the account) can reduce or otherwise limit the transmission of electronic communications over a data network from such an account. Reducing or otherwise limiting the transmission of electronic communications over the data network can reduce the data traffic between the server system 102 and one or more computing devices and thereby result in a more efficient use of the communication networks between the server system 102 and one or more computing devices over a data network 108.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
identifying a first active area of an electronic content item and a second active area of the electronic content item, wherein the first active area is distinguishable from the second active area based on a sensory indicator presented with the electronic content item, wherein each of the first and second active areas respectively comprises a respective portion of the electronic content item that receives input triggering at least one action;
receiving inputs to the electronic content item from an entity, wherein at least a subset of the inputs comprises interactions that are within the second active area rather than the first active area; and
determining, by a processing device, that activity by the entity is anomalous based at least partially on the subset of the interactions being within the second active area rather than the first active area.

2. The method of claim 1, wherein the sensory indicator comprises at least one of:
a visual indicator displayed with the electronic content item;
an audio signal that is played when the electronic content item is displayed; and
a tactile characteristic of a display device that is modified in a region at which the electronic content item is displayed.

3. The method of claim 1, wherein determining that the activity by the entity is anomalous based at least partially on the subset of the interactions comprises:
identifying a threshold amount of interaction within the second active area; and
determining that the subset of the inputs includes an amount of interaction within the second active area greater than the threshold amount of interaction.

4. The method of claim 3, further comprising:
receiving, from the entity, additional inputs to an additional electronic content item having an additional first active area that is distinguishable from an additional second active area based on the sensory indicator, wherein an additional subset of the additional inputs comprises additional interaction within the additional second active area rather than the additional first active area;
wherein determining that the activity by the entity is anomalous further comprises determining that the additional subset of the additional inputs includes an additional amount of interaction within the additional second active area that is greater than the threshold amount of interaction.

5. The method of claim 3, further comprising determining the threshold amount of interaction by performing operations comprising:
receiving additional inputs to the electronic content item from a plurality of additional entities; and
determining a distribution of the additional inputs between at least the first active area and the second active area, wherein the threshold amount of interaction is based on the distribution of the additional inputs.

6. The method of claim 1, wherein identifying the first active area and the second active area comprises:
designating the first active area using at least one of:
a visible characteristic identifying the first active area, wherein the visible characteristic is visible when the electronic content item is displayed in a graphical interface,
an audio signal identifying the first active area, wherein the audio signal is played when the electronic content item is displayed, and
a tactile characteristic of a display device, wherein the tactile characteristic is modified in a region at which the electronic content item is displayed; and
storing data identifying the first active area and the second active area in a non-transitory computer-readable medium.

7. The method of claim 1, wherein the first and second active areas are identified at least partially based on a plurality of click densities within the electronic content item, wherein the first active area has a greater click density than the second active area and further comprising storing data identifying the first active area and the second active area in a non-transitory computer-readable medium.

8. The method of claim 1, further comprising reporting to a provider of the electronic content item that the activity by the entity is anomalous.

9. The method of claim 1, further comprising:
receiving additional inputs from the entity; and
excluding the additional inputs from an analytical process based on determining that the activity by the entity is anomalous.

10. A system comprising:
a processing device; and
a non-transitory computer-readable medium communicatively coupled to the processing device,
wherein the processing device is configured to execute instructions stored on the non-transitory computer-readable medium to perform operations comprising:
identifying a first active area of an electronic content item and a second active area of the electronic content item, wherein the first active area is distinguishable from the second active area based on a sensory indicator presented with the electronic content item, wherein each of the first and second active areas respectively comprises a respective portion of the electronic content item that receives input triggering at least one action,
receiving inputs to the electronic content item from an entity, wherein at least a subset of the inputs comprises interactions that are within the second active area rather than the first active area, and
determining that activity by the entity is anomalous based at least partially on the subset of the interactions being within the second active area rather than the first active area.

11. The system of claim 10, wherein determining that the activity by the entity is anomalous based at least partially on the subset of the interactions comprises:
identifying a threshold amount of interaction within the second active area; and
determining that the subset of the inputs includes an amount of interaction within the second active area greater than the threshold amount of interaction.

12. The system of claim 11, wherein the operations further comprise receiving, from the entity, additional inputs to an additional electronic content item having an additional first active area that is distinguishable from an additional second active area based on the sensory indicator, wherein an additional subset of the additional inputs comprises additional interaction within the additional second active area rather than the additional first active area;
wherein determining that the activity by the entity is anomalous further comprises determining that the additional subset of the additional inputs includes an additional amount of interaction within the additional second active area that is greater than the threshold amount of interaction.

13. The system of claim 11, wherein the operations further comprise determining the threshold amount of interaction by performing additional operations comprising:
receiving additional inputs to the electronic content item from a plurality of additional entities; and
determining a distribution of the additional inputs between at least the first active area and the second active area, wherein the threshold amount of interaction is based on the distribution of the additional inputs.

14. The system of claim 10, wherein identifying the first active area and the second active area comprises designating the first active area using at least one of:
a visible characteristic identifying the first active area, wherein the visible characteristic is visible when the electronic content item is displayed in a graphical interface;
an audio signal identifying the first active area, wherein the audio signal is played when the electronic content item is displayed; and
a tactile characteristic of a display device, wherein the tactile characteristic is modified in a region at which the electronic content item is displayed.

15. The system of claim 10, wherein the first and second active areas are identified at least partially based on a plurality of click densities within the electronic content item, wherein the first active area has a greater click density than the second active area.

16. The system of claim 10, further comprising reporting to a provider of the electronic content item that the activity by the entity is anomalous.

17. A non-transitory computer-readable medium having program code stored thereon, the program code comprising:
program code for identifying a first active area of an electronic content item and a second active area of the electronic content item, wherein the first active area is distinguishable from the second active area based on a sensory indicator presented with the electronic content item, wherein each of the first and second active areas respectively comprises a respective portion of the electronic content item that receives input triggering at least one action;
program code for receiving inputs to the electronic content item from an entity, wherein at least a subset of the inputs comprises interactions that are within the second active area rather than the first active area; and
program code for determining that activity by the entity is anomalous based at least partially on the subset of the interactions being within the second active area rather than the first active area.

18. The non-transitory computer-readable medium of claim 17, wherein determining that the activity by the entity is anomalous based at least partially on the subset of the interactions comprises:
identifying a threshold amount of interaction within the second active area; and
determining that the subset of the inputs includes an amount of interaction within the second active area greater than the threshold amount of interaction.

19. The non-transitory computer-readable medium of claim 18, further comprising:
program code for receiving, from the entity, additional inputs to an additional electronic content item having an additional first active area that is distinguishable from an additional second active area based on the sensory indicator, wherein an additional subset of the additional inputs comprises additional interaction within the additional second active area rather than the additional first active area;
wherein determining that the activity by the entity is anomalous further comprises determining that the additional subset of the additional inputs includes an additional amount of interaction within the additional second active area that is greater than the threshold amount of interaction.

20. The non-transitory computer-readable medium of claim 17, wherein identifying the first active area and the second active area comprises designating the first active area using at least one of:
a visible characteristic identifying the first active area, wherein the visible characteristic is visible when the electronic content item is displayed in a graphical interface;
an audio signal identifying the first active area, wherein the audio signal is played when the electronic content item is displayed; and
a tactile characteristic of a display device, wherein the tactile characteristic is modified in a region at which the electronic content item is displayed.

21. The non-transitory computer-readable medium of claim 17, wherein the first and second active areas are identified at least partially based on a plurality of click densities within the electronic content item, wherein the first active area has a greater click density than the second active area.

22. The non-transitory computer-readable medium of claim 17, further comprising program code for reporting to a provider of the electronic content item that the activity by the entity is anomalous.
